(19) United States
(12) Patent Application Publication
(10) Pub. No.: US 2018/0198619 A1
(43) Pub. Date: Jul. 12, 2018

(54) A SECURING APPARATUS FOR AN APPLICATION IN AN ELECTRONIC DEVICE AND METHOD THEREOF

(71) Applicant: Boe Technology Group Co., Ltd., Beijing (CN)

(72) Inventors: Xiangyan Zhang, Beijing (CN); Yingyi Li, Beijing (CN)

(21) Appl. No.: 15/105,697

(22) PCT Filed: Dec. 29, 2015
(86) PCT No.: PCT/CN2015/099421

§ 371 Date: Jun. 17, 2016

(30) Foreign Application Priority Data
Jul. 1, 2015 (CN) 201510380058.8

(51) Int. Cl. H04L 9/32; G06F 21/32; G06F 21/51

(52) U.S. Cl. CPC H04L 9/3231; G06F 21/51; G06F 21/32

(57) ABSTRACT

The present disclosure provides a securing method and securing apparatus for an application, as well as an electronic device. The method comprises the steps of: after receiving a touch-sensitive instruction triggered by a user for opening a first application, displaying a first display frame for prompting the user to input a fingerprint key in an electronic device interface; receiving the fingerprint key input through the first display frame by the user; comparing the received fingerprint key with a preset encryption fingerprint key to obtain a matching result, the encryption fingerprint key being a key preset by the user for protecting the first application; and determining whether or not to open the first application according to the matching result. The method is capable of setting different encryption fingerprint keys for individual applications of the electronic device, so as to better protect the user information and improve user experiences.

### RELATED APPLICATIONS

The present application is the U.S. national phase entry of PCT/CN2015/099421, with an international filing date of Dec. 29, 2015, which claims the benefit of Chinese Patent Application No. 201510380058.8, filed on Jul. 1, 2015, the entire disclosures of which are incorporated herein by reference.

### TECHNICAL FIELD

The present disclosure relates to a securing apparatus for an application in an electronic device and methods thereof, as well as an electronic device.

### BACKGROUND ART

Currently, users have more and more demanding requirements for confidentiality of electronic devices, and an increasing number of electronic devices come out with security functions, such as unlocking mobile terminals on start-up by means of combined letters and/or digits, or unlocking an iPAD on start-up by means of a fingerprint.

In practical application, a user's information is often leaked through electronic devices with start-up unlocking functions. That is to say, the securing features in the above electronic devices can only conduct the start-up encryption of the electronic devices employing a Home button or a simple letter/digital combination. Once the start-up password gets leaked or the electronic device has been turned on and can be used directly by other users, the user information stored in various applications in the electronic device will soon be leaked out.

The security functions of the above electronic device are unable to secure every single application in the device separately, i.e., it is impossible to conduct separate security settings for some or all of the applications in a cellular phone, such that the user information stored in various applications in the electronic device is easily leaked out.

Thus, it is very urgent to solve the technical problem of how to provide specific protection to a particular application in an electronic device.

### SUMMARY

To overcome the above defects in the prior art, it is desirable to provide a securing apparatus for an application in an electronic device and methods thereof, as well as an electronic device, which are capable of setting different fingerprint encryption keys for individual applications in the electronic device, so as to better protect the user information and improve the user experience.

According to a first aspect of the present invention, there is provided a method of securing an application. The method comprises the steps of:

after receiving a touch-sensitive instruction triggered by a user for opening a first application, displaying a first display frame for prompting the user to input a fingerprint key in an electronic device interface;

receiving the fingerprint key input through the first display frame by the user;

comparing the received fingerprint key with a preset encryption fingerprint key to obtain a matching result, the encryption fingerprint key being a key preset by the user for protecting the first application; and

determining whether or not to open the first application according to the matching result.

In certain embodiments, the step of determining whether or not to open the first application according to the matching result comprises:

if the matching result is an exact match, displaying an interface of the first application in the electronic device interface; or

if the matching result is a mismatch, displaying a first prompt message indicative of a wrong input of the fingerprint key in the electronic device interface, and/or displaying a second prompt message indicative of remaining N chances left to input the fingerprint keys in the electronic device interface, and displaying the first display frame, wherein N is a positive integer greater than or equal to 1.

In certain embodiments, before the step of displaying a first display frame for prompting the user to input a fingerprint key in the electronic device interface, the method further comprises the steps of:

checking whether the first application is in a secured application list;

if yes, performing the step of displaying the first display frame in the electronic device interface; if not, directly displaying the interface of the first application in the electronic device interface.

In certain embodiments, before the step of displaying a first display frame for prompting the user to input a fingerprint key in an electronic device interface, the method further comprises the steps of:

if the user triggers an encryption button/key modification button of the first application in the electronic device, displaying a second display frame for prompting the user to input an encryption fingerprint key in the electronic device interface;

receiving the encryption fingerprint key input through the second display frame by the user; and

storing the encryption fingerprint key.

According to a second aspect of the present invention, there is provided a securing apparatus. The securing apparatus comprises:

a first display unit configured to display a first display frame for prompting the user to input a fingerprint key in an electronic device interface after receiving a touch-sensitive instruction triggered by a user for opening a first application;

a receiving unit configured to receive the fingerprint key input through the first display frame by the user;

a matching unit configured to match the received fingerprint key with a preset encryption fingerprint key to obtain a matching result, wherein the encryption fingerprint key is a key preset by the user for protecting the first application; and

a processing unit configured to determine whether or not to open the first application according to the matching result.

In certain embodiments, the processing unit is further configured for:

if the matching result is an exact match, displaying an interface of the first application in the electronic device interface according to the touch-sensitive instruction; or

if the matching result is a mismatch, displaying a first prompt message indicative of a wrong input of the fingerprint key in the electronic device interface, and/or displaying a second prompt message indicative of remaining N chances left to input the fingerprint keys in the electronic device interface, and displaying the first display frame, wherein N is a positive integer greater than or equal to 1.

In certain embodiments, the securing apparatus further comprises a checking unit. The checking unit is configured to check whether the first application is in a secured application list. Correspondingly, the first display unit is configured to display the first display frame when the checking unit determines that the first application is in the secured application list, or otherwise, directly display the interface of the first application in the electronic device interface.

In certain embodiments, the securing apparatus further comprises a second display unit and a storing unit. The second display unit is configured for: if the user triggers an encryption button/key modification button of the first application in the electronic device, displaying a second display frame for prompting the user to input an encryption fingerprint key in the electronic device interface. Correspondingly, the receiving unit is also configured to receive the encryption fingerprint key input through the second display frame by the user. The storing unit is configured to store the encryption fingerprint key.

According to the third aspect of the present invention, there is provided an electronic device. In the electronic device, a plurality of applications are installed. The electronic device further comprises any one securing apparatus as described above. The securing apparatus is integrated into the applications or is communicatively connected with the applications.

In certain embodiments, the electronic device comprises a touch-sensitive display substrate, a touch-sensitive display panel or a touch-sensitive display apparatus.

In certain embodiments, the touch-sensitive display substrate, the touch-sensitive display panel or the touch-sensitive display apparatus implements the full-screen fingerprint recognition technique.

As known from the above technical solutions, the securing method and securing apparatus of an application, as well as the electronic device, according to several aspects of the present invention can display a first display frame for prompting the user to input a fingerprint key after receiving a touch-sensitive instruction triggered by a user for opening a corresponding application, then receive a fingerprint key input through the first display frame by the user, matches the received fingerprint key with a preset encryption fingerprint key, and determine whether or not to open the application to which the touch-sensitive instruction corresponds according to the matching result. Therefore, some embodiments of the present invention can achieve at least one of the following advantageous effects and/or other advantageous effects: to better protect the user information in the applications, and to set different encryption fingerprint keys for individual applications in the electronic device so as to better protect the user information and improve user experience.

### BRIEF DESCRIPTION OF DRAWINGS

To explain the technical solutions in the embodiments of the present invention more clearly, the drawings to be used in the Detailed Description will be briefly introduced below. It should be realized that the following drawings are only some embodiments of the present invention. Those skilled in the art can obtain other drawings according to these drawings without making an inventive labour.

FIG. 1 is a schematic view showing the flow chart of a method of securing an application according to an embodiment of the present invention;

FIG. 2 is a schematic view showing the flow chart of a method of securing an application according to a further embodiment of the present invention;

FIG. 3 is a schematic view showing that a user touches an application to be opened in the electronic device according to an embodiment of the present invention; and

FIG. 4 is a structural schematic view of a securing apparatus according to an embodiment of the present invention.

### DETAILED DESCRIPTION

To assist those skilled in the art in better understanding the object, technical solutions and advantages of some embodiments of the present invention, the specific implementations of some embodiments of the present invention will be further described in detail with reference to the drawings and embodiments. The following embodiments are used to explain the present invention but not limit the scope of the present invention.

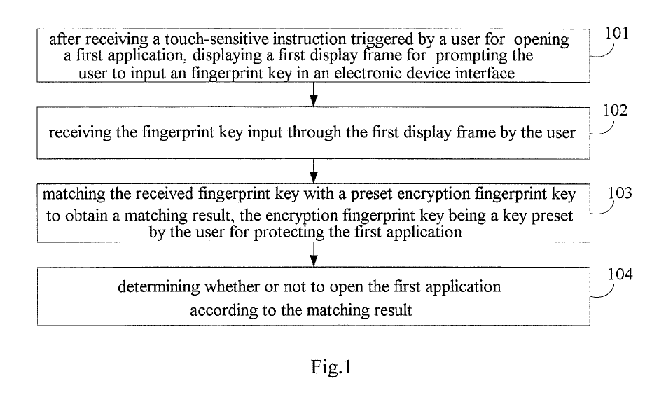

FIG. 1 shows a schematic flow chart of a method of securing an application according to an embodiment of the present invention. As shown in FIG. 1, the securing method of the application in the present embodiment is presented as follows:

Step 101: after receiving a touch-sensitive instruction triggered by a user for opening a first application, displaying a first display frame for prompting the user to input a fingerprint key in an electronic device interface.

For example, the first display frame may be an interface for inputting the fingerprint key, such as a fingerprint input interface.

Step 102: receiving a fingerprint key input through the first display frame by the user.

For example, when a finger of the user presses the first display frame, the fingerprint of the current finger of the user is scanned to obtain the fingerprint key. It can be understood that the fingerprint key herein may be made by one finger, or may be made by two or more fingers.

In other embodiments, the fingerprint key herein may be a fingerprint key being a combination of a fingerprint and other letters/digits. The present embodiment does not impose a limitation on the fingerprint key, which can be set as actually required.

Step 103: comparing the received fingerprint key with a preset encryption fingerprint key to obtain a matching result, the encryption fingerprint key being keys preset by the user for protecting the first application.

Step 104: determining whether or not to open the first application according to the matching result.

For example, if the matching result in step 104 is an exact match, the electronic device interface shows an interface of the first application, such as a main interface of the first application, namely, triggering and opening the first application corresponding to the touch-sensitive instruction.

In addition, if the matching result in step 104 is a mismatch, the electronic device interface shows a first prompt message indicative of wrong fingerprint keys, and/or the electronic device interface shows a second prompt message indicative of remaining N chances to input the fingerprint keys and the first display frame, N being a positive integer greater than or equal to 1. Namely, in the event of mismatch of the fingerprints, the user is allowed to input the fingerprint again for recognition. For example, N may be 2, 3 or 5.

The method of securing an application of the present embodiment displays a first display frame for prompting the user to input a fingerprint key after receiving a touch-sensitive instruction for the application triggered by a user, then receives a fingerprint key input through the first display frame by the user, matches the received fingerprint key with a preset encryption fingerprint key, and determines whether or not to open the application to which the current touch-sensitive instruction corresponds according to the matching result. Therefore, it is possible to better protect the user information in the application, and simultaneously to set different encryption fingerprint keys for individual applications in the electronic device so as to better protect the user information and improve the user experience.

In a specific implementation, the method shown in FIG. 1 may also comprise a step 100 not shown in the drawing, before the step 101.

Step 100: checking whether the first application is in a secured application list after the step of receiving a touch-sensitive instruction triggered by a user for opening the first application; if yes, performing the step of displaying the first display frame for prompting the user to input the fingerprint key in the electronic device interface in step 101; if not, directly displaying the main interface of the first application in the electronic device interface.

In practical application, the securing apparatus of each electronic device may be previously provided with a secured application list according to the user's instruction. Thus, when the user opens each application, it is checked whether the application is in the secured application list, thereby better protecting the user information in the electronic device. For instance, when a first user is using the mobile terminal owned by a second user, the second user does not want the first user to see his or her text messages, Wechat and Alipay. Then the second user may add the text message application, Wechat application and Alipay application into the secured application list. During the addition, an encryption fingerprint key may be set for each application in the second display frame displayed by the securing apparatus.

In the present embodiment, the full-screen fingerprint recognition technique may be utilized to conduct different fingerprint recognitions for different applications. For instance, the fingerprint may be input at a designated place on the electronic device display interface/display screen so as to be matched with the preset encryption fingerprint key and then determine whether or not to open the application as desired by the user according to the matching result, which thus effectively reduces the risk of leakage of the user information in various applications in the electronic device.

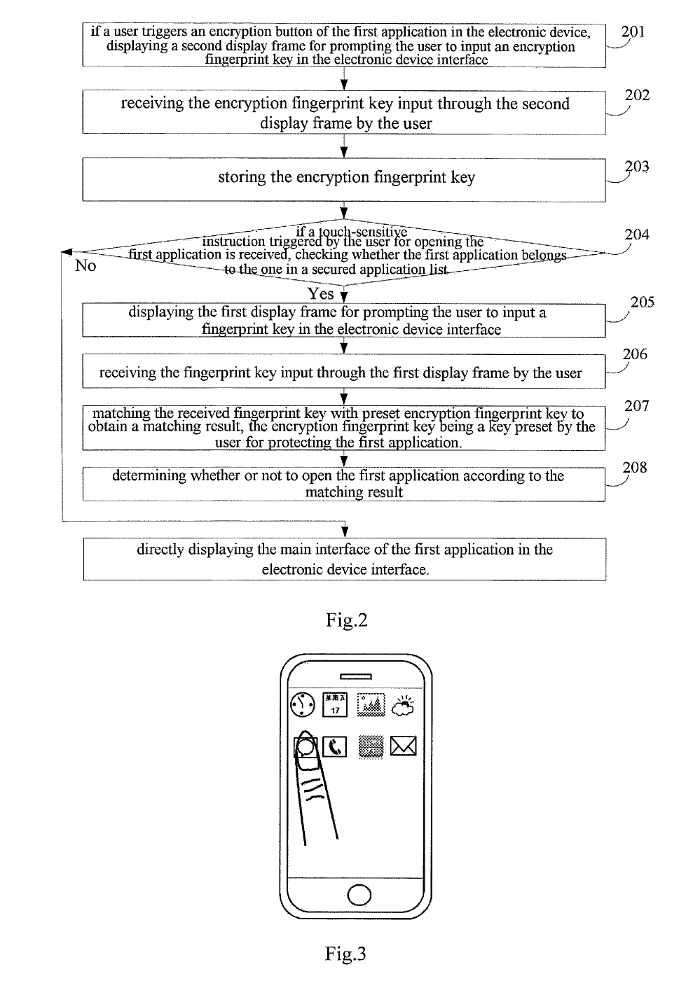

FIG. 2 shows a schematic flow chart of a method of securing an application according to an embodiment of the present invention. FIG. 3 shows a schematic view in which a user touches an application to be opened in the electronic device according to an embodiment of the present invention. As shown in FIGS. 2 and 3, the method of securing an application according to the present embodiment comprises the steps of:

Step 201: if the user triggers an encryption button of the first application in the electronic device, displaying a second display frame for prompting the user to input an encryption fingerprint key in the electronic device interface.

For example, the second display frame may be an interface for inputting the encryption fingerprint key, such as a fingerprint input interface.

Step 202: receiving the encryption fingerprint key input through the second display frame by the user.

Step 203: storing the encryption fingerprint key.

In the present embodiment, the encryption fingerprint key is not limited to using one fingerprint. Two or more fingerprints can also be selected as the encryption fingerprint key, and a combination of letters/digits/sliding directions with a fingerprint can also be selected as the encryption fingerprint key. The encryption fingerprint key may be different for different applications.

Step 204: checking whether the first application is in a secured application list if the touch-sensitive instruction for the user to trigger and open the first application is received; if yes, performing the step 205; otherwise, directly displaying the main interface of the first application in the electronic device interface.

For example, when the first application to be triggered and opened by the user in FIG. 3 is Wechat, it is to check whether the Wechat belongs to the application in the secured application list.

Step 205: when it is found in step 204 that the first application belongs to the application in the secured application list, displaying the first display frame for prompting the user to input a fingerprint key in the electronic device interface;

Step 206: receiving the fingerprint key input through the first display frame by the user.

Step 207: comparing the received fingerprint key with preset encryption fingerprint key to obtain a matching result, the encryption fingerprint key being a key preset by the user for protecting the first application.

Step 208: determining whether or not to open the first application according to the matching result. For instance, if the matching result in step 207 is an exact match, a main interface of the first application will be displayed in the electronic device interface.

In addition, if the matching result in step 207 is a mismatch, the electronic device interface shows a second prompt message indicative of verification failure of fingerprint keys, and the first application will not be opened.

Further, in the practical application, the user may also modify the encryption fingerprint key that has already been set. For instance, if the user triggers a key modification button for opening the key of the first application (e.g., Alipay or Wechat) in the electronic device, the second display frame for prompting the user to input the encryption fingerprint key can be displayed in the electronic device interface.

Then the encryption fingerprint key input through the second display frame by the user is received and the encryption fingerprint key is stored.

It should be explained that in the present embodiment, an encryption button/key modification button of a securing program/securing apparatus can be embedded in the menu of the application (such as Wechat or Aplipay), so that the securing program/securing apparatus will display the second display frame in the electronic device interface as the user triggers the encryption button/key modification button.

In another optional implementation, the applications to be secured, such as Alipay or Wechat, are added to the list in the securing apparatus, so as to monitor the touch-sensitive instruction for the applications in the electronic device triggered by the user in real time. If the touch-sensitive instruction is monitored, it is checked whether the application to which the touch-sensitive instruction corresponds belongs to the application in the secured application list. If yes, the first display frame is displayed and any touch-sensitive instruction is shielded from the application to which the touch-sensitive instruction corresponds. Only when it is verified that the received fingerprint key matches the preset encryption fingerprint key, can the application to which the touch-sensitive instruction corresponds be triggered to open.

For instance, if a user A borrows a cellular phone from a user B to play games and the user B does not want the user A to see the emails, text messages and photographs in the cellular phone, the user B may add the email application, text message application and photo application to the secured application list so as to effectively protect the user information in the cellular phone. Other applications in the cellular phone that need not to be protected, such as time, weather and news applications, need not be added to the secured application list. Thus, a particular application can only be opened by particular fingerprint recognition, which is no longer confined to unlocking of the cellular phone itself in the prior art, thereby effectively preventing the leakage of the user information and improving user experiences.

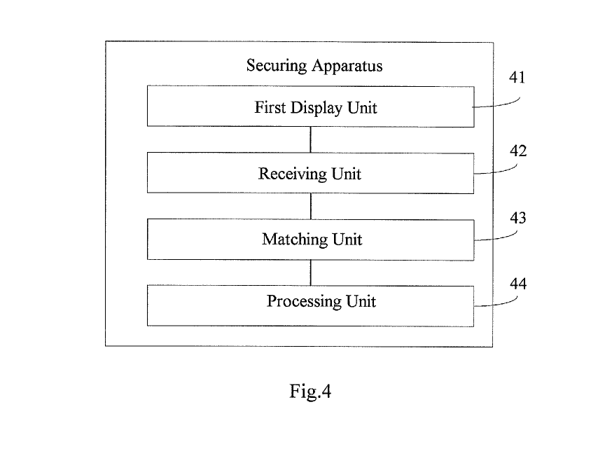

FIG. 4 shows a structural schematic view of a securing apparatus according to an embodiment of the present invention. As shown in FIG. 4, the securing apparatus of the present embodiment comprises a first display unit 41, a receiving unit 42, a matching unit 43 and a processing unit 44.

Therein the first display unit 41 is configured to display a first display frame for prompting the user to input a fingerprint key in an electronic device interface after receiving a touch-sensitive instruction triggered by a user for opening a first application.

The receiving unit 42 is configured to receive the fingerprint key input through the first display frame by the user;

The matching unit 43 is configured to match the received fingerprint key with a preset encryption fingerprint key to obtain a matching result, the encryption fingerprint key being a key preset by the user for protecting the first application.

The processing unit 44 is configured to determine whether or not to open the first application according to the matching result.

For example, the processing unit 44 is further configured for:

displaying an main interface of the first application in the electronic device interface according to said touch-sensitive instruction if the matching result is an exact match; or

if the matching result is a mismatch, displaying a first prompt message indicative of a wrong input of the fingerprint key in the electronic device interface, and/or displaying a second prompt message indicative of remaining N chances left to input the fingerprint keys in the electronic device interface, and displaying the first display frame, wherein N is a positive integer greater than or equal to 1.

In an optional implementation, the securing apparatus further comprises a checking unit 40 not shown in the drawing, which is configured to check whether the first application is in a secured application list.

Correspondingly, the first display unit 41 is further configured to display the first display frame when the checking unit 40 determines that the first application is in the secured application list; or otherwise, to directly display the main interface of the first application in the electronic device interface.

In another optional implementation, the securing apparatus in FIG. 4 may further comprise a second display unit that is not shown in the drawings described below.

The second display unit is configured for: before the first display unit 41 displays the first display frame, if the user triggers an encryption button/key modification button of the first application in the electronic device, displaying a second display frame for prompting the user to input encryption fingerprint key in the electronic device interface.

The receiving unit 42 is further configured to receive the encryption fingerprint key input through the second display frame by the user.

In addition, the securing apparatus may also comprise a storing unit that is not shown in the drawing. The storing unit is configured to store the encryption fingerprint key. For example, the encryption fingerprint key may be stored in a fingerprint database. The second display unit and the storing unit of the present embodiment are connected to each other, and the second display unit is connected with the aforementioned first display unit 41.

The securing apparatus may set different encryption fingerprint keys for individual applications to be secured in the electronic device, so as to keep these applications confidential, thereby better protecting the user information and improving user experiences.

The securing apparatus according to some embodiments of the present invention may be an APP program in the electronic device that is based on the full-screen fingerprint recognition technique. Moreover, the functions of the securing apparatus according to some embodiments of the present invention may also be integrated into any application of the electronic device, such as Wechat or Alipay, etc.

On the other hand, there is also provided an electronic device according to some embodiments of the present invention. The electronic device may comprise a plurality of applications. Further, the electronic device may also comprise the securing apparatus according to any of the above embodiments. The securing apparatus may be integrated into the applications, or the securing apparatus may be communicatively or electrically connected with the applications.

The electronic device in the above embodiments may comprise a touch-sensitive display substrate, a touch-sensitive display panel or a touch-sensitive display apparatus, etc. For example, the electronic device may be any product or component having displaying and touch-sensitive functions, such as a tablet, an intelligent terminal, iPAD, intelligent TV, or advertising device, etc. If the electronic device is an intelligent TV or intelligent advertising device, it is possible to authorize different users/members with different privileges of checking/setting various contents.

It shall be understood by those skilled in the art that all or part of steps of each of the above method embodiments can be done by the hardware related to a program instruction. The above-mentioned program may be stored in a computer-readable storage medium. The program, when executed, performs the steps of the above method embodiments. The aforementioned storage medium comprises various media capable of storing program codes, such as ROM, RAM, magnetic disks or optical disks, etc.

Finally, it must be explained that the above embodiments are only used to explain the technical solutions for some embodiments of the present invention, but not intended to limit the present invention. Although example implementations of the present invention are explained in detail with reference to the above embodiments, those ordinarily skilled in the art shall understand that they can still modify the technical solutions recited in the embodiments or make equivalent replacement of some or all of the technical features thereof, and the modification or replacement will not render the nature of the corresponding technical solutions departing from the scope delimited by the claims of the present invention. The protection scope of the present invention shall be based on the protection scope of the appended claims.

What needs to be explained is that some of the above embodiments are only illustrated by way of the individual function modules division. In actual application, the above functions can be allocated to different functional modules as desired. The internal structure of the apparatus/device can be divided into different functional modules so as to accomplish all or part of the functions as stated above. In addition, function(s) of the above one module can be achieved by a plurality of modules, and functions of the plurality of modules can be integrated into one module.

The term “and/or” used herein is only used to describe the connecting relations between objects connected thereby, which may be of three types. For instance, “A and/or B” can represent the following three situations: either A alone, or B alone, or both A and B. In addition, the character “/” used herein generally indicates that the former and the latter objects connected thereby is in a “or” relationship.

The terms such as “first”, “second” and “third” used herein are only for depiction and identification, and shall not be understood as an indication or implication of order without additional contexts. For example, the phrases “first edition” and “second edition” do not necessarily mean that the first edition is the very first edition, or created before the second edition, or even requested or operated before the second edition. In fact, these phrases are only used to indicate different editions.

In the claims, any reference sign in parentheses should not be interpreted as a limitation to the claims. The term “comprise/include” does not exclude the presence of elements or steps other than those listed in the claims. The word “a” or “an” in front of elements do not exclude the presence of a plurality of such elements. The present invention may be achieved by hardware comprising a plurality of separate elements, or by properly programmed software or firmware, or by any combination thereof.

In device or system claims that enumerate several means, one or more of the means can be embodied in one and the same item of hardware. The mere fact that some measures are recited in dependent claims that are different from each other does not indicate that the combination of the measures cannot be used to advantage.

1. A method of securing an application comprising the steps of:
receiving a touch-sensitive instruction triggered by a user for opening a first application;
displaying a first display frame for prompting the user to input a fingerprint key in an electronic device interface;
receiving the fingerprint key input from the user through the first display frame;
comparing the received fingerprint key with a preset encryption fingerprint key to obtain a matching result, wherein the encryption fingerprint key is a key preset by the user for protecting the first application; and
determining whether or not to open the first application according to the matching result.

2. The method according to claim 1, wherein the step of determining whether or not to open the first application according to the matching result comprises:
if the matching result is an exact match, displaying an interface of the first application in the electronic device interface; or
if the matching result is a mismatch, displaying a first prompt message indicative of a wrong input of the fingerprint key in the electronic device interface, or displaying a second prompt message indicative of remaining N chances left to input the fingerprint keys in the electronic device interface, and displaying the first display frame, wherein N is a positive integer greater than or equal to 1.

3. The securing method according to claim 1, further comprising the step of:
checking whether the first application is in a secured application list;
if yes, performing the step of displaying the first display frame in the electronic device interface; if no, directly displaying the interface of the first application in the electronic device interface.

4. The method according to claim 1 further comprising the steps of:
if the user triggers an encryption button/key modification button of the first application in the electronic device, displaying a second display frame for prompting the user to input an encryption fingerprint key in the electronic device interface;
receiving the encryption fingerprint key input from the user through the second display frame; and
storing the encryption fingerprint key.

5. A securing apparatus, comprising:
a first display unit configured to display a first display frame for prompting the user to input a fingerprint key in an electronic device interface after receiving a touch-sensitive instruction triggered by a user for opening a first application;
a receiving unit configured to receive the fingerprint key input from the user through the first display frame;
a matching unit configured to match the received fingerprint key with a preset encryption fingerprint key to obtain a matching result, wherein the encryption fingerprint key is a key preset by the user for protecting the first application; and
a processing unit configured to determine whether or not to open the first application according to the matching result.

6. The securing apparatus according to claim 5, wherein the processing unit
displays an interface of the first application in the electronic device interface according to the touch-sensitive instruction, if the matching result is an exact match; or
displays a first prompt message indicative of a wrong input of the fingerprint key in the electronic device interface, or displays a second prompt message indicative of remaining N chances left to input the fingerprint keys in the electronic device interface, and displays the first display frame, if the matching result is a mismatch;
wherein N is a positive integer greater than or equal to 1.

7. The securing apparatus according to claim 5 further comprising a checking unit configured to check whether the first application is in a secured application list,
wherein the first display unit is configured to display the first display frame when the checking unit determines that the first application is in the secured application list or to directly display the interface of the first application in the electronic device interface.

8. The securing apparatus according to claim 5, wherein the securing apparatus further comprises a second display unit and a storing unit,
wherein the second display unit is configured to display a second display frame for prompting the user to input an encryption fingerprint key in the electronic device interface, if the user triggers an encryption button/key modification button of the first application in the electronic device;
wherein the receiving unit is configured to receive the encryption fingerprint key input from the user through the second display frame; and
wherein the storing unit is configured to store the encryption fingerprint key.

9. An electronic device having a plurality of applications installed, wherein the electronic device further comprises a securing apparatus
comprising:
a first display unit configured to display a first display frame for prompting the user to input a fingerprint key in an electronic device interface after receiving a touch-sensitive instruction triggered by a user for opening a first application;
a receiving unit configured to receive the fingerprint key input from the user through the first display frame;
a matching unit configured to match the received fingerprint key with a preset encryption fingerprint key to obtain a matching result, wherein the encryption fingerprint key is a key preset by the user for protecting the first application; and
a processing unit configured to determine whether or not to open the first application according to the matching result,
wherein the securing apparatus is integrated into the applications or is communicatively connected with the applications.

10. The electronic device according to claim 9 further comprising a touch-sensitive display substrate, a touch-sensitive display panel or a touch-sensitive display apparatus.

11. The electronic device according to claim 10, wherein the touch-sensitive display substrate, the touch-sensitive display panel or the touch-sensitive display apparatus achieves the full-screen fingerprint recognition technique.

12. The method according to claim 2 further comprising the steps of:
if the user triggers an encryption button/key modification button of the first application in the electronic device, displaying a second display frame for prompting the user to input an encryption fingerprint key in the electronic device interface if the user triggers an encryption button/key modification button of the first application in the electronic device;
receiving the encryption fingerprint key input from the user through the second display frame; and
storing the encryption fingerprint key.

13. The securing apparatus according to claim 6, further comprising a second display unit and a storing unit,
wherein the second display unit is configured to display a second display frame for prompting the user to input an encryption fingerprint key in the electronic device interface, if the user triggers an encryption button/key modification button of the first application in the electronic device;
wherein the receiving unit is also configured to receive the encryption fingerprint key input from the user through the second display frame by the user; and
wherein the storing unit is configured to store the encryption fingerprint key.

14. The electronic device according to claim 9, wherein the processing unit is further configured to
display an interface of the first application in the electronic device interface according to the touch-sensitive instruction, if the matching result is an exact match; or
display a first prompt message indicative of a wrong input of the fingerprint key in the electronic device interface, display a second prompt message indicative of remaining N chances left to input the fingerprint keys in the electronic device interface, and displaying the first display frame, if the matching result is a mismatch;
wherein N is a positive integer greater than or equal to 1.

15. The electronic device according to claim 9, wherein the securing apparatus further comprises a checking unit configured to check whether the first application is in a secured application list,
wherein the first display unit is configured to display the first display frame when the checking unit determines that the first application is in the secured application list, or otherwise, directly displaying the interface of the first application in the electronic device interface.

16. The electronic device according to claim 9, wherein the securing apparatus further comprises a second display unit and a storing unit,
the second display unit is configured to:
if the user triggers an encryption button/key modification button of the first application in the electronic device, display a second display frame for prompting the user to input an encryption fingerprint key in the electronic device interface;
wherein the receiving unit is configured to receive the encryption fingerprint key input from the user through the second display frame; and
wherein the storing unit is configured to store the encryption fingerprint key.

17. The electronic device according to claim 14, wherein the securing apparatus further comprises a second display unit and a storing unit, the second display unit is configured for:
if the user triggers an encryption button/key modification button of the first application in the electronic device, display a second display frame for prompting the user to input an encryption fingerprint key in the electronic device interface;
wherein the receiving unit is configured to receive the encryption fingerprint key input from the user through the second display frame; and
wherein the storing unit is configured to store the encryption fingerprint key.
